(19) United States
(12) Patent Application Publication
(10) Pub. No.: US 2016/0085004 A1
(43) Pub. Date: Mar. 24, 2016

(54) DISAPPEARING IMAGE SCREEN PROTECTOR

(71) Applicants: Vicki Hamberg, Tacoma, WA (US); Todd Hagmann, Tacoma, WA (US)

(72) Inventors: Vicki Hamberg, Tacoma, WA (US); Todd Hagmann, Tacoma, WA (US)

(21) Appl. No.: 14/493,105

(22) Filed: Sep. 22, 2014

(51) Int. Cl. G02B 5/23; G02F 1/01; G02B 1/14

(52) U.S. Cl. CPC G02B 5/23; G02B 1/14; G02F 1/0147

(57) ABSTRACT

A disappearing image screen protector for displaying an illustration on the display screen of an electronic device when the screen is off and becoming transparent when the screen is on. The disappearing image screen protector comprises a modified screen protector having top shield layer and a screen layer. The top shield layer is optically transparent and the screen layer is optically transparent but includes photochromic paint, dye, and/or ink arranged therein in a selected image, design, and/or text. The disappearing image screen protector attaches to the display screen of the mobile phone, displaying the age, design, and/or text in the screen layer when the display screen is off and being optically transparent when the display screen is on.

### BACKGROUND OF THE INVENTION

1. Field of the Invention

This invention relates generally to mobile device accessories and, more particularly, to a screen protector for a mobile device having an image which becomes invisible when light from the screen passes through it.

2. Description of the Prior Art

The use of conventional screen protectors to place on the display screen of various handheld devices, such as mobile phones or tablet computers is well known. Such screen protectors are commonly thin plastic bodies having an adhesive side and are generally clear or tinted to enable the images on the screen to be easily seen while the screen protector is in place over the screen. A problem which still exists, however, is that existing screen protectors generally are not useful to add a unique style or finish to the handheld devices as it remains paramount that they enable full visibility of the screen. Thus, there remains a need for a disappearing image screen protector that includes an integrated illustration, defined as a selected design and/or text, without affecting the visibility of the screen it is placed on. It would be helpful if such a disappearing image screen protector included photochromic material to enable it to change the color of the integrated illustration to clear when light emanates from the screen. It would be additionally desirable for such a disappearing image screen protector included a plurality of layers to ensure only light from the screen caused the color change to clear.

The Applicant's invention described herein provides for a disappearing image screen protector adapted to provide a visible image on a screen protector that disappears when the screen is in use. The primary components in Applicant's disappearing image screen protector are a screen layer including photochromic dyes and/or paints and a clear, top shield layer disposed over the screen later. When in operation, the photochromic dyes and/or paints enables customization of the screen of a handheld device without impairing visibility of the screen when it is in use. As a result, many of the limitations imposed by prior art structures are removed.

### SUMMARY OF THE INVENTION

A disappearing image screen protector for displaying an illustration on the display screen of an electronic device when the screen is off and becoming transparent when the screen is on. The disappearing image screen protector comprises a modified screen protector having top shield layer and a screen layer. The top shield layer is optically transparent and the screen layer is optically transparent but includes photochromic paint, dye, and/or ink arranged therein in a selected image, design, and/or text. The disappearing image screen protector attaches to the display screen of the mobile phone, displaying the age, design, and/or text in the screen layer when the display screen is off and being optically transparent when the display screen is on.

It is an object of this invention to provide a disappearing image screen protector that includes an integrated illustration without affecting the visibility of the screen it is placed on.

It is another object of this invention to provide a disappearing image screen protector that utilizes photochromic material to enable it to change the color of the integrated illustration to clear when light emanates from the screen.

It is yet another object of this invention to provide a disappearing image screen protector that utilizes a plurality of layers to ensure only light from the screen causes the desired color change.

These and other objects will be apparent to one of skill in the art.

### BRIEF DESCRIPTION OF THE DRAWINGS

FIG. 1 is a side perspective view of a mobile phone having a disappearing image screen protector built in accordance with the present invention disposed thereon with its display screen off.

FIG. 2 is a front elevational view of a disappearing image screen protector built in accordance with the present invention disposed thereon with no light behind it.

FIG. 3 is a side perspective view of a mobile phone having a disappearing image screen protector built in accordance with the present invention disposed thereon with its display screen on.

FIG. 4 is a front elevational view of a disappearing image screen protector built in accordance with the present invention disposed thereon with light behind it.

FIG. 5 is a side elevational view of a disappearing image screen protector built in accordance with the present invention.

### DETAILED DESCRIPTION OF THE INVENTION

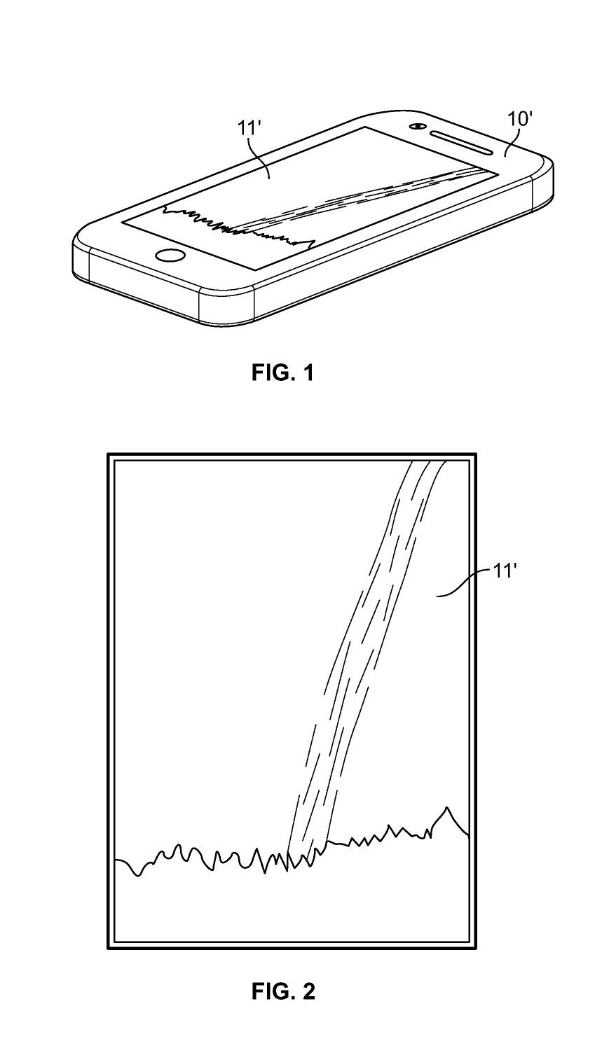

Referring now to the drawings and in particular FIGS. 1 and 2, a disappearing image screen protector 11′ is shown disposed over a the display screen of a conventional mobile phone 10′ with its display screen off. The disappearing image screen protector 11′ attaches to the display screen of the mobile phone 10′ in the same manner(s) as conventional screen protectors. In the preferred embodiment, the disappearing image screen protector 11′ attaches to the display screen through the use of an adhesive.

When the display screen of the mobile phone 10′ is off, with no light emanating therefrom, an the disappearing image screen protector 11′ includes an integrated illustration that is visible to the naked eye. It is contemplated that the integrated illustration on any one disappearing image screen protector 11′ can be substantially any image, design, and/or text that can be created solely through the use of photochromic paint, dye, and/or ink.

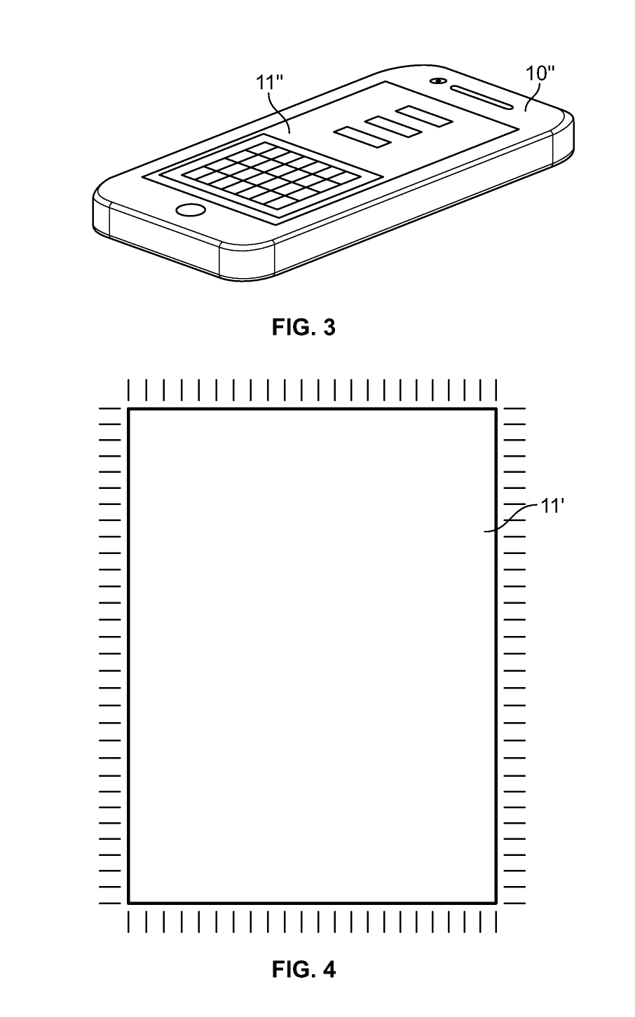

Referring now to FIGS. 3 and 4, when a disappearing image screen protector 11″ is disposed on the display screen of a conventional mobile phone 10″ with its display screen on and therefore emitting light, the photochromic paint, dye, and/or ink turns to clear, which causes the integrated illustration to disappear. As such, when the display screen is being used, as determined by the emission of light therefrom, the disappearing image screen protector 11″ becomes clear and allows an unobstructed view of the display screen.

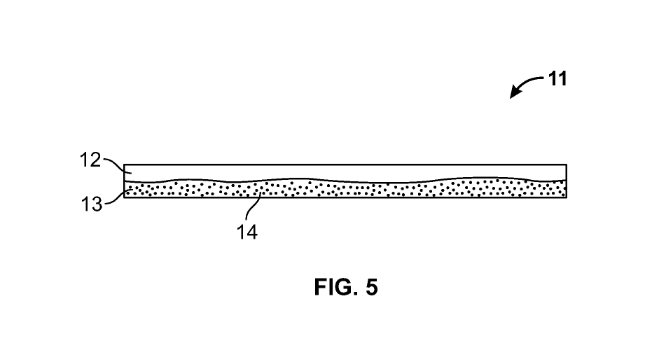

Referring now to FIGS. 1, 2, 3, 4, and 5, the disappearing image screen protector 11′, 11″ in accordance with the present invention (collectively 11) includes a top shield layer 12 and a screen layer 13. The top shield layer 12 is clear, containing no material that will impair viewing of a screen therethrough. The screen layer 13 is the layer that is placed closest to the display screen of the handheld device when the disappearing image screen protector 11 is in use. The screen layer 13 includes therein an integrated illustration that is made up of photochromic paint, dye, and/or ink embedded therein. It is contemplated that the top shield layer 12 is optically transparent, reflecting minimal light to enable the display screen to be visible therethrough but also preventing ambient light from interacting sufficiently with the screen layer 13 to cause the integrated illustration to disappear (as long as the ambient light is not focused toward the disappearing image screen protector 11).

In an alternate embodiment, thermochromic paint, dye, and/or ink is used in the screen layer in addition to, or place of, photochromic paint, dye, and/or ink. In such embodiments, it is contemplated that the thermochromic material is clear when cool and turns into a selected color when heat from the display screen is absorbed by the screen layer.

It is contemplated that the disappearing image screen protector can be used with any display screen which emits light (and heat, in thermochromic embodiments), including computers, televisions, and the like.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A disappearing image screen protector for placement on the display screen of an electronic device, comprising a screen layer attached to the top shield layer and constructed of optically transparent material, wherein the screen layer additionally includes photochromic material that turns clear when exposed to light emitted by a display screen on which the disappearing image screen protector is placed.

2. The disappearing image screen protector for placement on the display screen of an electronic device of claim 1, additionally comprising a top shield layer constructed of optically transparent material

3. The disappearing image screen protector for placement on the display screen of an electronic device of claim 2, wherein the screen layer additionally includes thermochromic material that turns clear when exposed to heat emitted by a display screen on which the disappearing image screen protector is placed.

4. The disappearing image screen protector for placement on the display screen of an electronic device of claim 1, wherein the screen layer additionally includes thermochromic material that turns clear when exposed to heat emitted by a display screen on which the disappearing image screen protector is placed.

5. A disappearing image screen protector for placement on the display screen of an electronic device, comprising:
top shield layer constructed of optically transparent material; and
a screen layer attached to the top shield layer and constructed of optically transparent material, wherein the screen layer additionally includes thermochromic material that turns clear when exposed to heat emitted by a display screen on which the disappearing image screen protector is placed.

6. The disappearing image screen protector for placement on the display screen of an electronic device of claim 5, wherein the screen layer additionally includes photochromic material that turns clear when exposed to light emitted by a display screen on which the disappearing image screen protector is placed
